(19) United States
(12) Patent Application Publication
(10) Pub. No.: US 2018/0296436 A1
(43) Pub. Date: Oct. 18, 2018

(54) TYPE OF ACUPUNCTURE NEEDLE USED FOR FSN

(71) Applicant: Nanjing FSN Medical Co.,Ltd., Jiangsu (CN)

(72) Inventor: Zhonghua FU, Nanjing (CN)

(21) Appl. No.: 15/578,849

(22) PCT Filed: Feb. 18, 2016
(86) PCT No.: PCT/CN2016/073997

§ 371 Date: Dec. 1, 2017

(30) Foreign Application Priority Data
Jun. 2, 2015 (CN) 201510297191.7

(51) Int. Cl. A61H 39/08

(52) U.S. Cl. CPC A61H 39/083; A61H 2201/0173; A61H 39/086

(57) ABSTRACT

The present invention relates to a type of medical instrument, in particular a type of acupuncture needle used for Fu's subcutaneous needling (FSN), comprising a needle handle, a needle body, and a protecting sheath, wherein the needle handle and the needle body are integrated to an integral part. The needle body is suitable for FSN, has reduced elasticity, and facilitates the sweeping movement. The needle handle adopts the design of hollow structure, made of hard plastic to facilitate manufacture, save manufacture materials, and facilitate grasp for operation. The cross section of the middle part of the needle handle is a polygon to improve stability of placing of the floating needle. Top part of the protecting sheath can be inserted into the needle handle and its tail part is round, to allow longer arm of force and better sweep when used by a doctor with large hands. This instrument features simple process, easy manufacture and storage, easy use, high safety, and good sanitation.

### TECHNICAL FIELD

The present invention relates to a type of medical instrument, in particular a type of acupuncture needle used for FSN.

### BACKGROUND OF THE INVENTION

The present invention is dedicated for FSN, which was invented by this inventor in 1996 when working for the First Military Medical University. In this acupuncture therapy, FSN is used for acupuncture activity such as sweep in subcutaneous layer around localized pain. This technique is the product of combining traditional acupuncture with modern medical science, in particular, combining inheritance and promotion of ancient acupuncture scientific ideas and precious practical experience with achievements of modern research of acupuncture. This technique features wide range of indication, fast and definite curative effect, easy operation, safety, and no side-effect. It has wide application for various clinical branches, especially for treatment of pain.

Different from traditional acupuncture, FSN requires horizontal or elliptic subcutaneous sweep (i.e. the sweeping movement). Since large force is required for the sweeping movement, the following is necessary: 1. thick and sufficiently long needle handle to allow exerting force; 2. relatively thick steel needle without too large elasticity such that of traditional acupuncture needle.

In the present market, acupuncture needles are normally relatively thin and have thin handle and large needle body elasticity, not suitable for the sweeping movement. In a new type of acupuncture needle (application No. 200710023701.7), needle core is deep inside and fixed in the needle handle (which adopts a solid structure) but such needle has thin handle and large elasticity.

In one type of disposable acupuncture needle (application No. 201020203521.4), when the needle is fitted in the sleeve, the handle is engaged with the bulge in the round cavity inside the sleeve, so that there is no relative sliding between the handle and the sleeve. Also, the lower end of the needle body is hidden in the sleeve to protect the needle tip. For use, press the sleeve complete with the needle on the acupoint, quickly press the needle handle so that the needle body pierces the skin from the sleeve, into corresponding acupoint. Then, remove the sleeve to start acupuncture. This type of acupuncture needle has relatively high requirement on manufacture, and requires the holding seam to clamp the needle handle, as well as moderate holding force.

### SUMMARY OF THE INVENTION

FSN requires special needle. This invention proposes a type of acupuncture needle for FSN that features simple manufacture process, easy manufacture and storage, easy use, high safety, good sanitation, and good effect.

The technical scheme of this invention is described below: a type of acupuncture needle used for FSN, comprising a needle handle, a needle body, and a protecting sheath, wherein the needle handle and the needle body are integrated to an integral part. The needle body is suitable for FSN and has reduced elasticity, improved treatment effect, and reduced production cost. The needle handle adopts the design of hollow structure, and is thick and long (as compared with traditional acupuncture needle) and made of hard plastic to facilitate grasp for sweep, while saving materials. The cross section of the middle part of the needle handle is a polygon to improve stability of placing on desk. Top part of the protecting sheath can be inserted into the needle handle. For use, insert the protecting sheath into the needle handle, to allow longer arm of force for sweep by a doctor with large hands, and saving of force. This instrument features simple process, easy manufacture and storage, easy use, high safety, good sanitation, and good effect.

As preference, cross section of middle part of the needle handle is square, needle handle internal contour is round, and protecting sheath top part is also round.

This invention has the following beneficial effects: The needle handle is far thickner than handle of traditional acupuncture needle. The needle body is relatively thick and has good rigidity. This needle facilitates exerting force for sweep and adopts relatively thick needle core with low elasticity, not easily rolling when placed on a plane. It features simple manufacture process and light weight, saving manufacture materials, preventing bending during storage, and facilitating production and storage. It also features easy use, good stability upon placing high safety, good sanitation, relatively low elasticity, accurate needle insertion, and good treatment effect.

### DESCRIPTION OF DRAWING FIGURES

FIG. 1 is a schematic of overall structure of preferred embodiment of this invention.

FIG. 2 is a front view of overall structure of preferred embodiment of this invention.

FIG. 3 is a left view of overall structure of preferred embodiment of this invention.

FIG. 4 is a bottom view of overall structure of preferred embodiment of this invention.

FIG. 5 is a structural schematic of the protecting sheath of preferred embodiment of this invention.

### PREFERRED EMBODIMENT

The following describes this invention in details in combination with the drawing figures and a preferred embodiment.

Example: a type of acupuncture needle used for FSN, comprising a needle handle, a needle body, and a protecting sheath, wherein the needle handle and the needle body are integrated to an integral part. The needle handle adopts the design of round hollow structure, made of hard medical plastic to facilitate manufacture, save manufacture materials, and prevent bending of floating needle during storage. The cross section of the middle part of the needle handle is a rectangle to prevent continuous rolling of the floating needle.

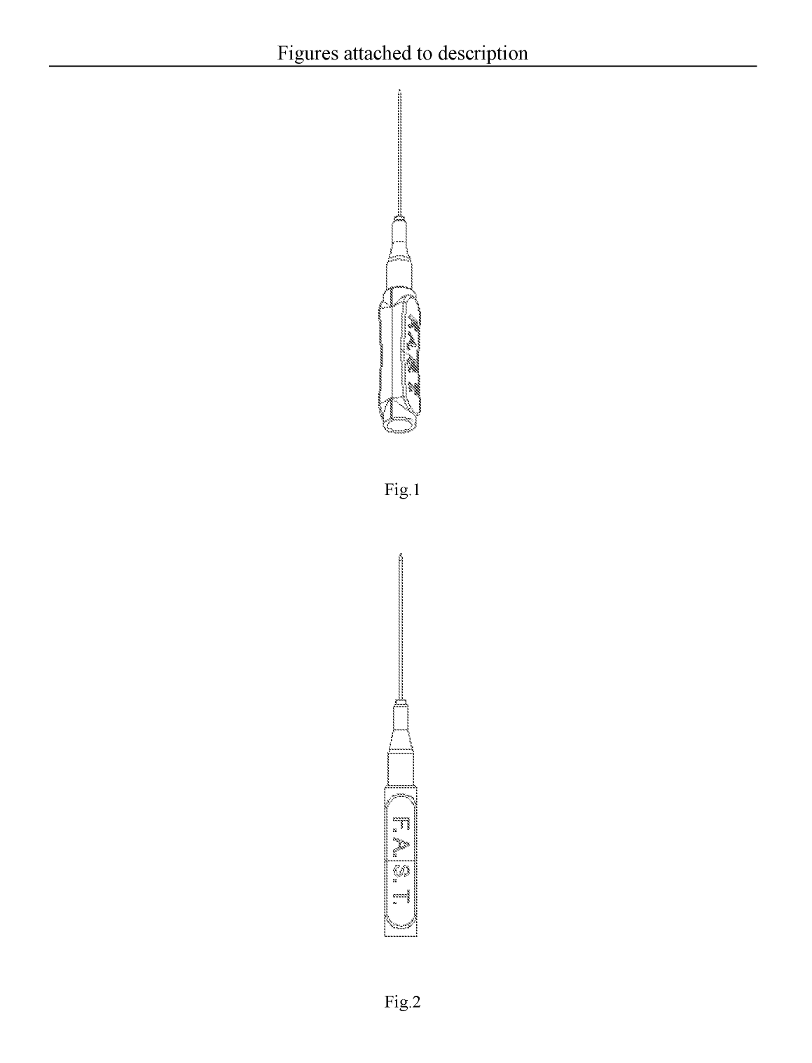

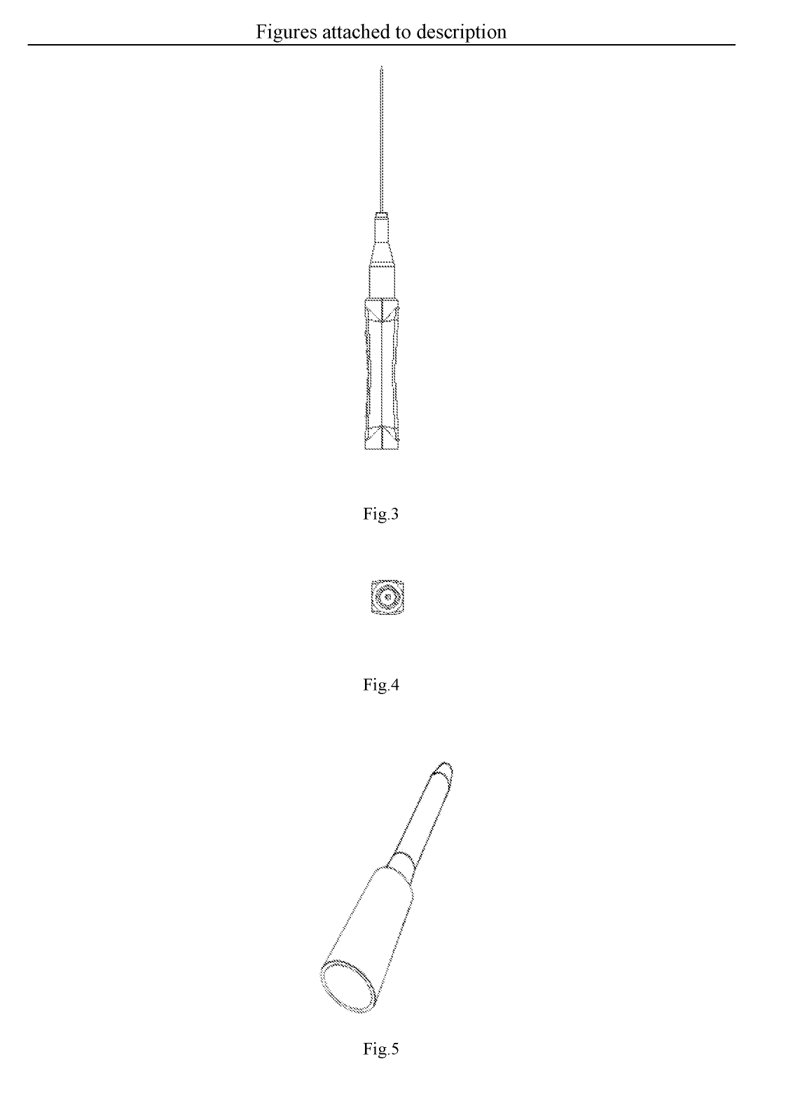

Select two opposed faces of the needle handle and set them concave, with embossed pattern on one of them to increase friction and facilitate holding by hand. For example, the pattern may be “F.A.S.T.” shown in FIG. 1-3. For use, insert top part of the protecting sheath into the round hollow structure of the needle handle to facilitate twirling and lifting of the needle by doctor.

Such design ensures small space occupied by the floating needle during storage and sufficient length for use, facilitating sweep.

FIG. 4 is a bottom view of preferred embodiment of this invention and FIG. 5 is a structural schematic of the protecting sheath of preferred embodiment of this invention.

This preferred embodiment is only a good example of this invention and not intended to limit this invention. Any modification, equivalent replacement, or improvement within the concept and principle of this invention shall be included in the scope of protection of this invention.

1. A type of acupuncture needle used for FSN, comprising a needle handle, a needle body, and a protecting sheath, wherein said needle handle and the needle body are integrated to an integral part, said needle handle is far thicker than handle of traditional acupuncture needle, and said needle body is relatively thick and has good rigidity.

2. The acupuncture needle used for FSN of claim 1, wherein said needle handle is square to facilitate grasp and avoid rolling.

3. The acupuncture needle used for FSN of claim 1, wherein said needle handle has a hollow structure, polygon cross section of its middle part, and is made of hard plastic.

4. The acupuncture needle used for FSN of claim 1, wherein top part of said protecting sheath matches the hollow structure of said needle handle, tail part of said protecting sheath is round, and top part of said protecting sheath can be inserted into said needle handle for use.
